(19) United States
(12) Patent Application Publication
(10) Pub. No.: US 2010/0202800 A1
(43) Pub. Date: Aug. 12, 2010

(54) Line Head and Image Forming Apparatus

(75) Inventors: Takeshi SOWA, Matsumoto-shi (JP); Yujiro NOMURA, Shiojiri-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/688,645

(22) Filed: Jan. 15, 2010

(30) Foreign Application Priority Data
Feb. 10, 2009 (JP) 2009-029026

(51) Int. Cl. G03G 15/04; B41J 2/447

(52) U.S. Cl. 399/218; 347/238

(57) ABSTRACT

A line head includes light-emitting elements arranged in a first direction; and an optical system that images light emitted from the light-emitting elements on a latent image carrier. The optical system including first and second lens surfaces having refractive power, the second lens surface being provided on a side of the first lens surface opposite to the light-emitting elements. In cross sections in the first and second directions including an optical axis of the optical system, the curvatures of the first and second lens surfaces satisfy the following relationships: |C_{1X}|<|C_{1Y}|; and |C_{2X}|>|C_{2Y}| where, |C_{1X}| and |C_{2X}| are absolute values of the curvatures on the optical axis of the first and second lens surfaces on the cross section in the first direction, respectively; and |C_{1Y}| and |C_{2Y}| are absolute values of the curvatures on the optical axis of the first and second lens surfaces on the cross section in the second direction.

### CROSS-REFERENCE TO RELATED APPLICATIONS

This application claims the benefit of priority under 35 USC 119 of Japanese application no. 2009-029026, filed on Feb. 10, 2009, which is incorporated herein by reference.

### BACKGROUND

1. Technical Field

The present invention relates to a line head and an image forming apparatus.

2. Related Art

Electrophotographic image forming apparatuses such as copying machines or printers are provided with an exposure unit that performs an exposure process on an outer surface of a rotating photoconductor so as to form an electrostatic latent image thereon. As the exposure unit, a line head having a structure in which a plurality of light-emitting elements is arranged in the direction of the rotation axis of the photoconductor is known (for example, see JP-A-2-4546)

As the line head, for example, JP-A-2-4546 describes an optical information writer in which a plurality of LED array chips is arranged in one direction.

In the optical information writer, convex lens elements are provided so as to correspond to the respective LED array chips. The convex lens elements image the light from LEDs that are provided to each of the LED array chip.

In the line head described in JP-A-2-4546, due to the image-surface curvature of the convex lens element, the imaging capability of the convex lens element decreases as it becomes distant from the optical axis. On the surface of the photoconductor, a spot size of light from an LED that is located distant from the optical axis of the convex lens element is larger than a spot size of light from an LED that is located close to the optical axis of the convex lens element.

For this reason, the size of the latent image formed on the surface of the photoconductor becomes uneven between a pixel, which is formed by the light from the LED located close to the optical axis of the convex lens element, and a pixel, which is formed by the light from the LED located distant from the optical axis of the convex lens element. As a result, the images finally obtained from the latent image may have uneven concentration.

### SUMMARY

An advantage of some aspects of the invention is that it provides a line head that performs a high-accuracy exposure process and an image forming apparatus that obtains a high-quality image.

The above-described advantage is achieved by the following aspects and embodiments of the invention.

According to an aspect of the invention, a line head includes light-emitting elements arranged in a first direction; and an optical system that images light emitted from the light-emitting elements on a latent image carrier. The optical system is provided with: a first lens surface having refractive power; and a second lens surface having refractive power that is provided on a side of the first lens surface opposite to the light-emitting elements. In a cross section in the first direction including an optical axis of the optical system and a cross section in a second direction including the optical axis, the second direction being orthogonal to the cross section in the first direction, the curvatures of the first and second lens surfaces satisfy the following relationships: |C_{1X}|<|C_{1Y}| and |C_{2X}|>|C_{2Y}|, where, |C_{1X}| is the absolute value of the curvature on the optical axis of the first lens surface on the cross section in the first direction; |C_{2X}| is the absolute value of the curvature on the optical axis of the second lens surface on the cross section in the first direction; |C_{1Y}| is the absolute value of the curvature on the optical axis of the first lens surface on the cross section in the second direction; and |C_{2Y}| is the absolute value of the curvature on the optical axis of the second lens surface on the cross section in the second direction.

In one embodiment, the optical system includes a first lens having the first lens surface and a second lens having the second lens surface.

In another embodiment, the first lens has a flat surface on an opposite side to the first lens surface.

In another embodiment, the first lens surface of the first lens opposes the light-emitting elements.

In another embodiment, an aperture diaphragm is provided close to a front-side focal plane of the optical system.

According to another aspect of the invention, an image forming apparatus includes a latent image carrier on which a latent image is formed; and a line head that performs exposure on the latent image carrier to form the latent image. The line head comprises: light-emitting elements arranged in a first direction; and an optical system that images light emitted from the light-emitting elements on a latent image carrier. The optical system is provided with: a first lens surface having refractive power; and a second lens surface having refractive power that is provided on a side of the first lens surface opposite to the light-emitting elements. In a cross section in the first direction including an optical axis of the optical system and a cross section in a second direction including the optical axis, the second direction being orthogonal to the cross section in the first direction, the curvatures of the first and second lens surfaces satisfy the following relationships: |C_{1X}<|C_{1Y}|; and |C_{2X}|>|C_{2Y}|, where, |C_{1X}| is the absolute value of the curvature on the optical axis of the first lens surface on the cross section in the first direction; |C_{2X}| is the absolute value of the curvature on the optical axis of the second lens surface on the cross section in the first direction; |C_{1Y}| is the absolute value of the curvature on the optical axis of the first lens surface on the cross section in the second direction; and |C_{2Y}| is the absolute value of the curvature on the optical axis of the second lens surface on the cross section in the second direction.

According to the line head of the invention having the above-described configuration, the image-surface curvature of the optical system is suppressed to be small. Therefore, variation in the spot size on a projection surface (light receiving surface) due to a different angle of view is decreased, thus suppressing unevenness in spot size. As a result, the line head of the invention realizes a high-accuracy exposure process.

Moreover, according to the image forming apparatus of the invention, by realizing the above-described high-accuracy exposure process, a high-quality image is obtained in which concentration unevenness is suppressed.

### BRIEF DESCRIPTION OF THE DRAWINGS

The invention will be described with reference to the accompanying drawings, wherein like numbers reference like elements.

FIG. 1 is a schematic view of an image forming apparatus according to an embodiment of the invention.

FIG. 2 is a partially sectional perspective view of a line head included in the image forming apparatus of FIG. 1.

FIG. 3 is a cross-sectional view taken along line III-III of FIG. 2.

FIG. 4 is a plan view of the line head of FIG. 2, illustrating the positional relationship between lenses and light-emitting elements.

FIG. 5 is a cross-sectional view, taken along the first direction, of an optical system included in the line head of FIG. 2.

FIG. 6 is a view for describing the imaging point of the optical system of FIG. 5.

FIG. 7 is a view for describing the operation of the optical system of FIG. 5.

FIG. 8 is a view illustrating an optical system included in a line head according to an Example of the invention.

FIG. 9 is a graph illustrating the image-surface curvature of an optical system included in a line head according to an Example of the invention.

### DESCRIPTION OF EXEMPLARY EMBODIMENTS

A line head and an image forming apparatus according to embodiments of the invention are now described in detail with reference to the accompanying drawings.

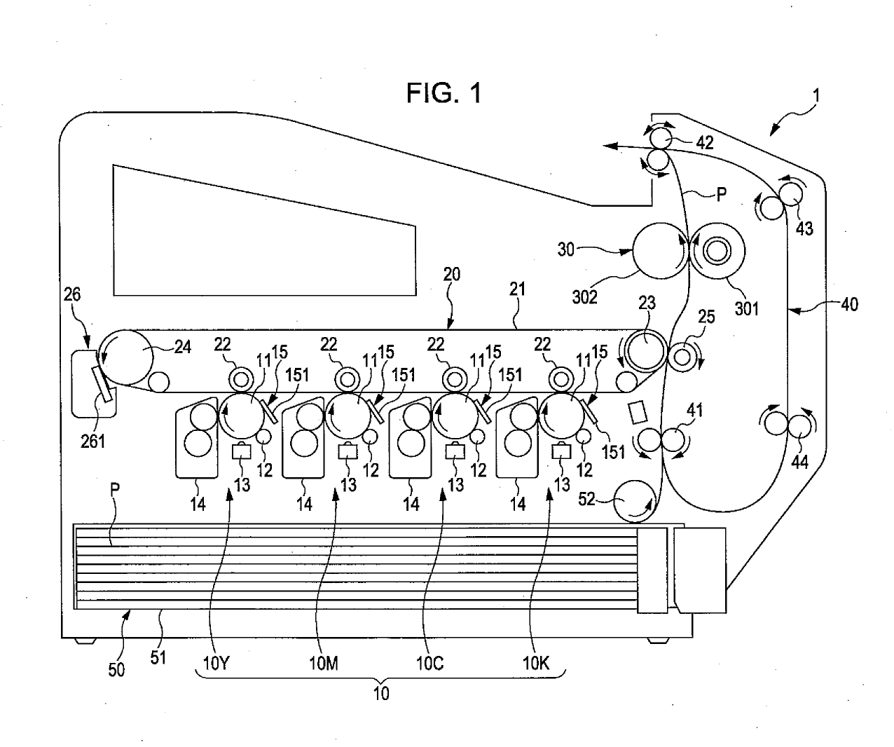

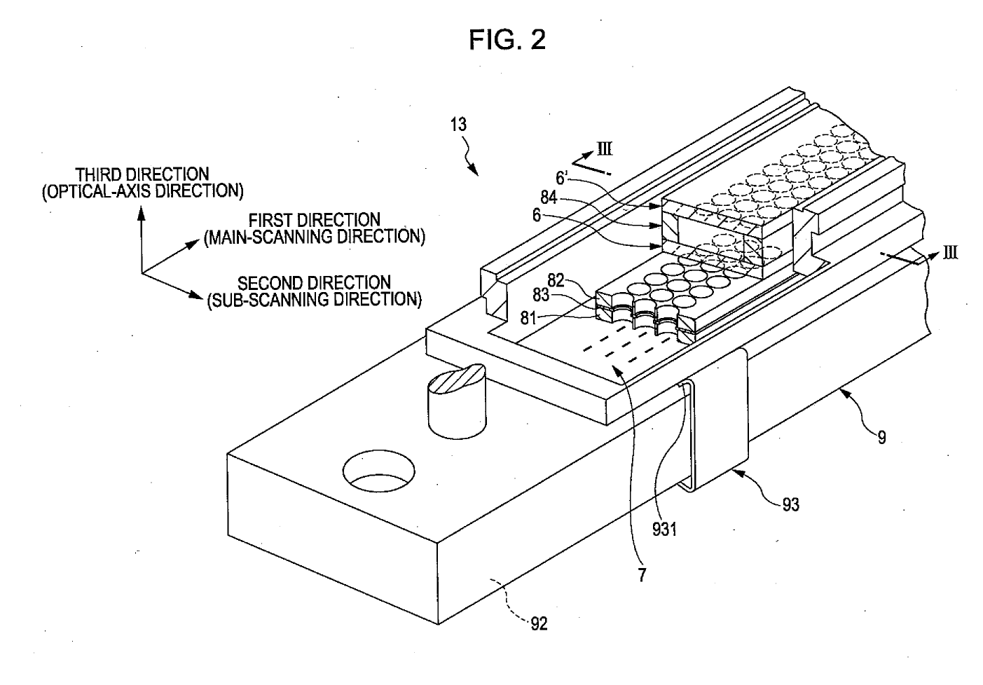

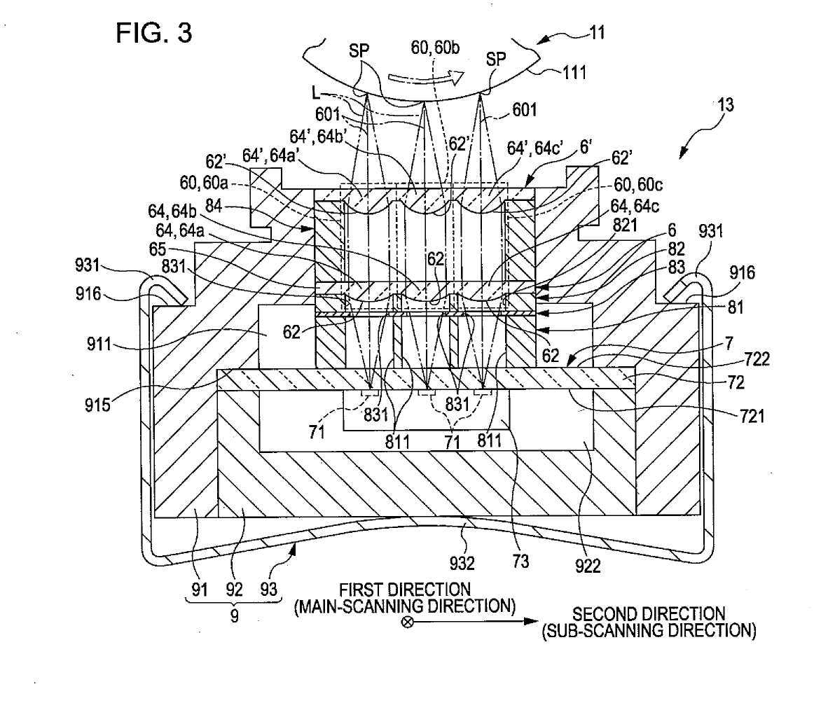

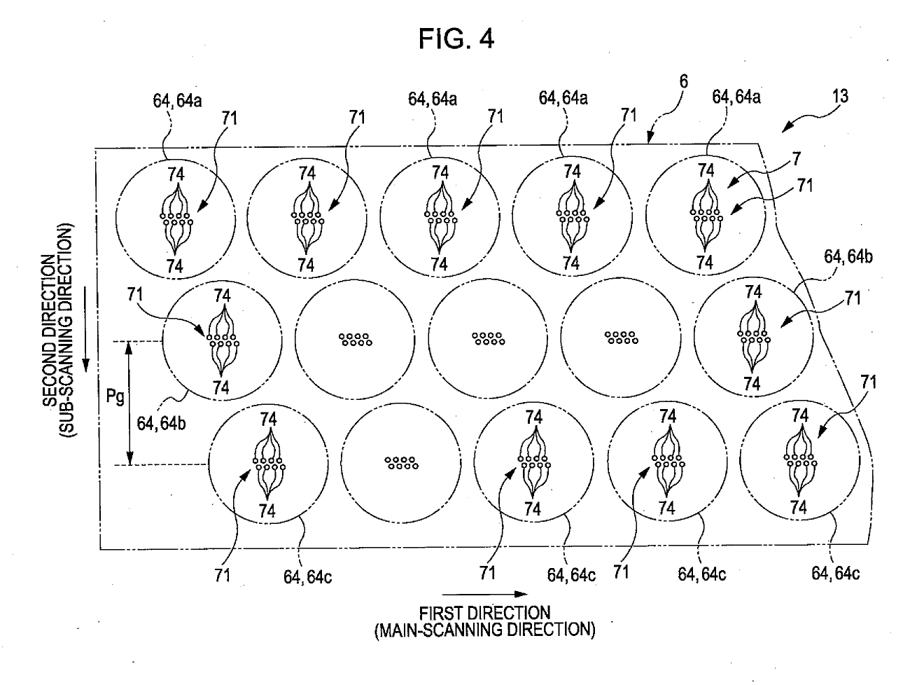

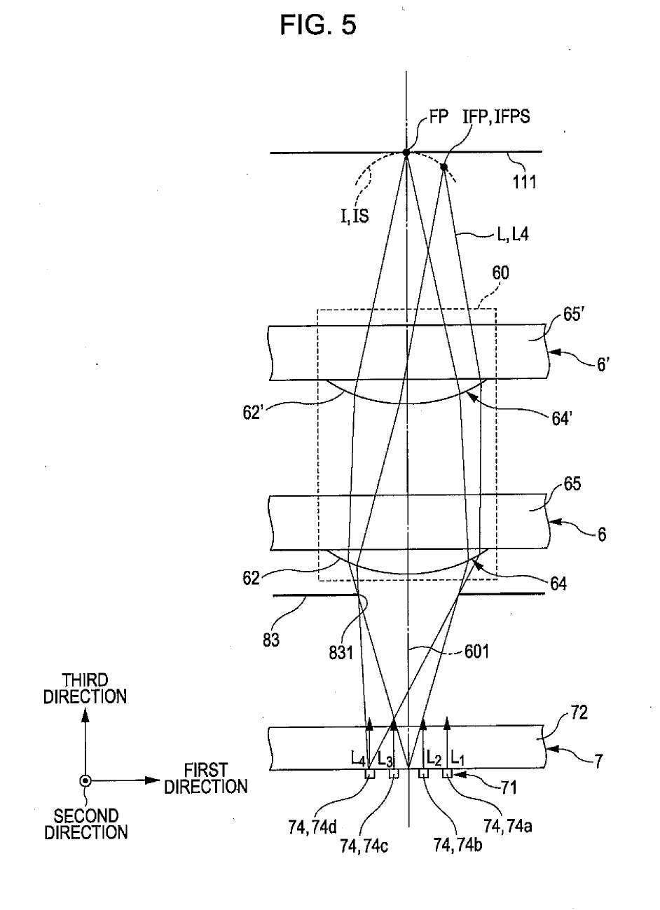

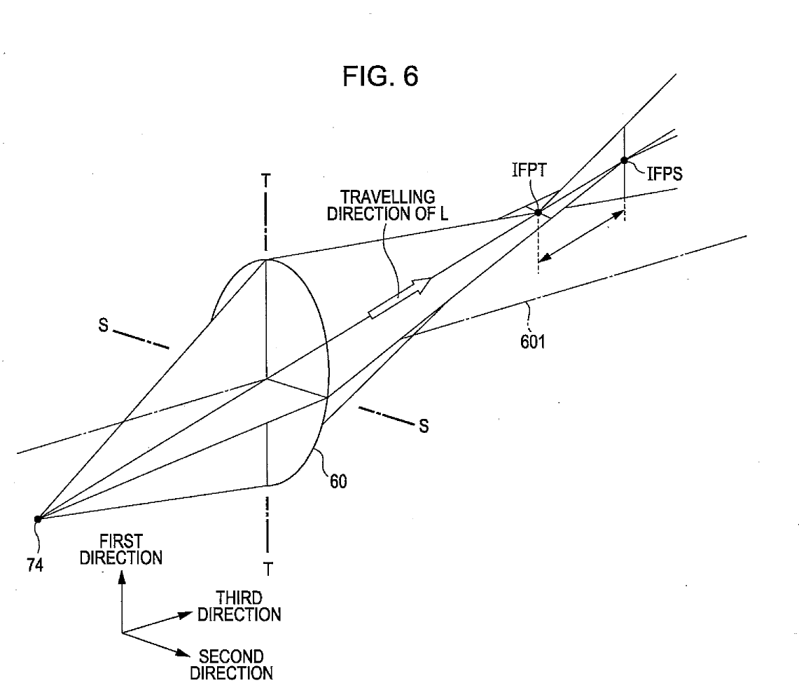

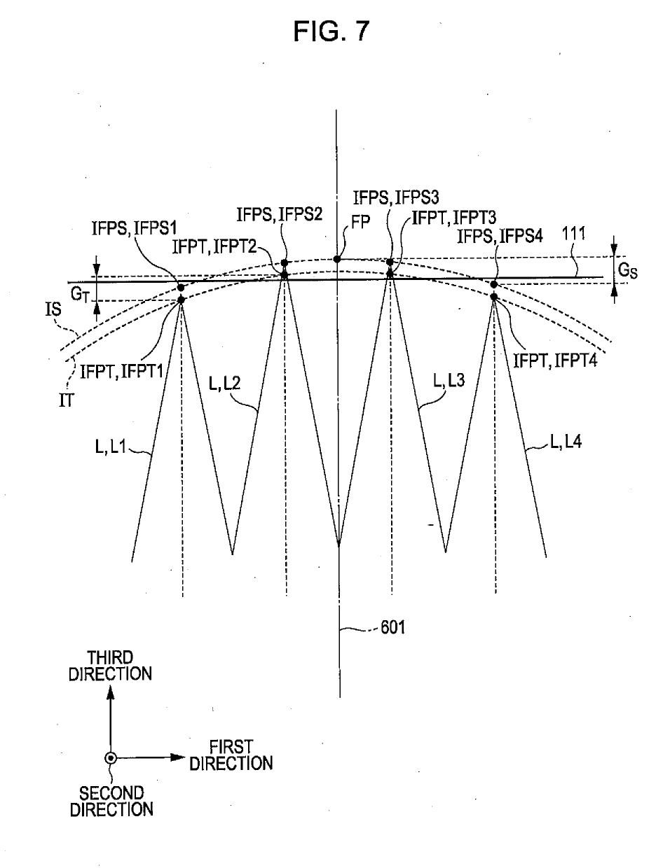

FIG. 1 is a schematic view of an image forming apparatus according to an embodiment of the invention. FIG. 2 is a partially sectional perspective view of a line head included in the image forming apparatus of FIG. 1. FIG. 3 is a cross-sectional view taken along line of FIG. 2. FIG. 4 is a plan view of the line head of FIG. 2, illustrating the positional relationship between lenses and light-emitting elements. FIG. 5 is a cross-sectional view, taken along the first direction so as to include an optical axis, of an optical system included in the line head of FIG. 2. FIG. 6 is a view for describing the imaging point of the optical system of FIG. 5. FIG. 7 is a view for describing the operation of the optical system of FIG. 5. In the following description, an upper side in FIGS. 1-3 and FIG. 5 is referred to as “upper” or “upward” and a lower side in the drawings is referred to as “lower” or “downward” for convenience of explanation.

### Image Forming Apparatus

Image forming apparatus 1 of FIG. 1 is an electrophotographic printer that records an image on a recording medium P by a series of image forming processes including an electrical charging process, an exposure process, a developing process, a transferring process, and a fixing process. In this embodiment, the image forming apparatus 1 is a tandem type color printer.

As illustrated in FIG. 1, the image forming apparatus 1 includes: an image forming unit 10 for the electrical charging process, the exposure process, and the developing process; a transfer unit 20 for the transferring process; a fixing unit 30 for the fixing process; a transport mechanism 40 for transporting the recording medium P, such as paper; and a paper feed unit 50 that supplies the recording medium P to the transport mechanism 40.

The image forming unit 10 has four image forming stations: an image forming station 10Y that forms a yellow toner image, an image forming station 10M that forms a magenta toner image, an image forming station 10C that forms a cyan toner image, and an image forming station 10K that forms a black toner image.

Each of the image forming stations 10Y, 10C, 10M, and 10K has a photosensitive drum (photoconductor) 11 that carries an electrostatic latent image thereon. A charging unit 12, a line head (exposure unit) 13, a developing unit 14, and a cleaning unit 15 are provided around the periphery (outer peripheral side) of the photosensitive drum 11 along a rotating direction thereof. The image forming stations 10Y, 10C, 10M, and 10K have substantially the same configurations except that they use toner of different colors.

The photosensitive drum 11 has an overall cylindrical shape and is rotatable around an axial line thereof along the direction indicated by the arrow in FIG. 1. A photosensitive layer is formed in the vicinity of the outer peripheral surface (cylindrical surface) of the photosensitive drum 11. The outer peripheral surface of the photosensitive drum 11 forms a light receiving surface 111 that receives light L (emitted light) from the line head 13.

The charging unit 12 uniformly charges the light receiving surface 111 of the photosensitive drum 11 by corona charging or the like.

The line head 13 receives image information from a host computer such as a personal computer and irradiates the light L towards the light receiving surface 111 of the photosensitive drum 11 in response to the image information. When the light L is irradiated to the uniformly charged light receiving surface 111 of the photosensitive drum 11, a latent image (electrostatic latent image) corresponding to an irradiation pattern of the light L is formed on the light receiving surface 111. The configuration of the line head 13 is described in detail later.

The developing unit 14 has a reservoir storing toner therein and supplies toner from the reservoir to the light receiving surface 111 of the photosensitive drum 11 that carries the electrostatic latent image and applies toner thereon. As a result, the latent image on the photosensitive drum 11 is visualized (developed) as a toner image.

The cleaning unit 15 has a cleaning blade 151, which is made of rubber and makes abutting contact with the light receiving surface 111 of the photosensitive drum 11, and is configured to remove toner, which remains on the photosensitive drum 11 after a primary transfer to be described later, by scraping the remaining toner with the cleaning blade 151.

The transfer unit 20 is configured to collectively transfer toner images corresponding to respective colors, which are formed on the photosensitive drums 11 of the image forming stations 10Y, 10M, 10C, and 10K described above, onto the recording medium P.

In each of the image forming stations 10Y, 10C, 10M, and 10K, electrical charging of the light receiving surface 111 of the photosensitive drum 11 performed by the charging unit 12, exposure of the light receiving surface 111 performed by the line head 13, supply of toner to the light receiving surface 111 performed by the developing unit 14, primary transfer to an intermediate transfer belt 21, caused by pressure between the intermediate transfer belt 21 and a primary transfer roller 22, which will be described later, and cleaning of the light receiving surface 111 performed by the cleaning unit 15 are sequentially performed while the photosensitive drum 11 rotates once.

The transfer unit 20 has the intermediate transfer belt 21 having an endless belt shape. The intermediate transfer belt 21 is stretched over the plurality (four in the configuration of FIG. 1) of primary transfer rollers 22, a driving roller 23, and a driven roller 24. The intermediate transfer belt 21 is driven to rotate in the direction indicated by the arrow in FIG. 1 and at approximately the same speed as a circumferential speed of the photosensitive drum 11 by rotation of the driving roller 23.

Each primary transfer roller 22 is provided opposite the corresponding photosensitive drum 11 with the intermediate transfer belt 21 interposed therebetween and is configured to transfer (primary transfer) a monochrome toner image on the photosensitive drum 11 to the intermediate transfer belt 21. At the time of primary transfer, a primary transfer voltage (primary transfer bias), which has an opposite polarity to that of electrically charged toner, is applied to the primary transfer roller 22.

A toner image corresponding to at least one of the colors yellow, magenta, cyan, and black is carried on the intermediate transfer belt 21. For example, when a full color image is formed, toner images corresponding to the four colors yellow, magenta, cyan, and black are sequentially transferred onto the intermediate transfer belt 21 so as to overlap one another so that a full color toner image is formed as an intermediate transfer image.

In addition, the transfer unit 20 has a secondary transfer roller 25, which is provided opposite the driving roller 23 with the intermediate transfer belt 21 interposed therebetween, and a cleaning unit 26, which is provided opposite the driven roller 24 with the intermediate transfer belt 21 interposed therebetween.

The secondary transfer roller 25 is configured to transfer (secondary transfer) a monochrome or full-color toner image (intermediate transfer image), which is formed on the intermediate transfer belt 21, to the recording medium P such as paper, a film, or cloth, which is supplied from the paper feed unit 50. At the time of secondary transfer, the secondary transfer roller 25 is pressed against the intermediate transfer belt 21, and a secondary transfer voltage (secondary transfer bias) is applied to the secondary transfer roller 25. The driving roller 23 also functions as a backup roller of the secondary transfer roller 25 at the time of such secondary transfer.

The cleaning unit 26 has a cleaning blade 261, which is made of rubber and makes abutting contact with a surface of the intermediate transfer belt 21, and is configured to remove toner, which remains on the intermediate transfer belt 21 after the secondary transfer, by scraping the remaining toner with the cleaning blade 261.

The fixing unit 30 has a fixing roller 301 and a pressure roller 302 pressed against the fixing roller 301 and is configured such that the recording medium P passes between the fixing roller 301 and the pressure roller 302. In addition, the fixing roller 301 is provided with a heater that is provided at an inside thereof, so as to heat an outer peripheral surface of the fixing roller 301 so that the recording medium P passing between the fixing roller 301 and the pressure roller 302 can be heated and pressed. By the fixing unit 30 having such a configuration, the recording medium P having a secondary-transferred toner image thereon is heated and pressed, such that the toner image is heat-fixed on the recording medium P as a permanent image.

The transport mechanism 40 has a resist roller pair 41, which transports the recording medium P to a secondary transfer position while calculates the timing of paper feeding to the secondary transfer position between the secondary transfer roller 25 and the intermediate transfer belt 21 described above, and transport roller pairs 42, 43, and 44 which pinch and transport only the recording medium P, on which the fixing process in the fixing unit 30 has been completed.

When an image is formed on only one surface of the recording medium P, the transport mechanism 40 pinches and transports the recording medium P, in which one surface thereof has been subjected to the fixing process by the fixing unit 30, using the transport roller pair 42 and discharges the recording medium P to the outside of the image forming apparatus 1. When images are formed on both surfaces of the recording medium P, the recording medium P in which one surface thereof has been subjected to the fixing process by the fixing unit 30 is first pinched by the transport roller pair 42. Then, the transport roller pair 42 is reversely driven and the transport roller pairs 43 and 44 are driven so as to reverse the recording medium P upside down and transport the recording medium P back to the resist roller pair 41. Then, another image is formed on the other surface of the recording medium P by the same operation as described above.

The paper feed unit 50 is provided with a paper feed cassette 51, which stores therein the recording medium P that has not been used, and a pickup roller 52 that feeds the recording medium P from the paper feed cassette 51 toward the resist roller pair 41 one at a time.

### Line Head

The line head 13 is now described in detail. In the following description, the longitudinal direction (first direction) of a long lens array 6 is referred to as a “main-scanning direction” and the width direction (second direction) of the lens array 6 is referred to as a “sub-scanning direction” for convenience of explanation.

As illustrated in FIG. 3, the line head 13 is arranged below the photosensitive drum 11 so as to oppose the light receiving surface 111 of the photosensitive drum 11. The line head 13 includes a lens array (first lens array) 6′, a spacer 84, the lens array (second lens array) 6, a light shielding member (first light shielding member) 82, a diaphragm member (aperture diaphragm) 83, a light shielding member (second light shielding member) 81, and a light-emitting element array 7, which are sequentially arranged in that order from the side of the photosensitive drum 11 and are accommodated in a casing 9.

In the line head 13, the light L emitted from the light-emitting element array 7 is collimated by the diaphragm member 83 and sequentially passes through the lens array 6′ and the lens array 6 to be irradiated onto the light receiving surface 111 of the photosensitive drum 11.

As illustrated in FIG. 2, the lens arrays 6 and 6′ are formed of a planar member having a long appearance.

As illustrated in FIG. 3, a plurality of curved lens surfaces (convex surfaces) 62 is formed on a lower surface (incidence surface) of the lens array 6 on which the light L is incident. On the other hand, an upper surface (emission surface) of the lens array 6 from which the light L is emitted is configured as a flat surface.

That is to say, the lens array 6 includes a plurality of piano-convex lenses 64, each of the lenses having a convex surface on a surface on which the light L is incident and a flat surface on a surface from which the light L is emitted. Here, a portion of the lens array 6 excluding the respective lenses 64 constitutes a support portion 65 that supports each of the lenses 64.

Similarly, on a lower surface (incidence surface) of the lens array 6′ on which the light L is incident, a plurality of curved lens surfaces (convex surfaces) 62′ is formed so as to correspond to the plurality of lens surfaces 62 described above. On the other hand, an upper surface (emission surface) of the lens array 6′ from which the light L is emitted is configured as a flat surface.

That is to say, the lens array 6′ includes a plurality of piano-convex lenses 64′, each of the lenses having a convex surface on a surface on which the light L is incident and a flat surface on a surface from which the light L is emitted. Here, a portion of the lens array 6′ excluding the respective lenses 64′ constitutes a support portion 65′ that supports each of the lenses 64′.

A plurality of lens pairs 64 and 64′ constitutes an optical system 60 that images light emitted from corresponding light-emitting elements 74 of a light-emitting element group 71 (see FIG. 5). The optical system 60 (particularly, the shapes of the lens surfaces of the lenses 64 and 64′) will be described in detail later.

The arrangement of the lenses 64 is now described. Since the lenses 64′ have the same arrangement (in plan view) as the lenses 64, the description thereof is omitted.

As illustrated in FIG. 4, the lenses 64 are arranged in plural columns in the main-scanning direction (first direction), and are arranged in plural rows in the sub-scanning direction (second direction) which is orthogonal to the main-scanning direction and the optical axis direction of the lenses 64.

More specifically, the plurality of lenses 64 are arranged in a matrix of three rows by n columns (n is an integer of two or more). In the following description, among the three lenses 64 belonging to one column (lens array), the lens 64 positioned in the middle is referred to as a “lens 64b”, the lens 64 positioned at a left side in FIG. 3 (upper side in FIG. 4) is referred to as a “lens 64a”, and the lens 64 positioned at a right side in FIG. 3 (lower side in FIG. 4) is referred to as a “lens 64c”. In the lenses 64′ that are paired with the lenses 64, the lens 64′ corresponding to the lens 64a is referred to as a “lens 64a′”, the lens 64′ corresponding to the lens 64b is referred to as a “lens 64b′”, and the lens 64′ corresponding to the lens 64c is referred to as a “lens 64c′”.

In this embodiment, the line head 13 is mounted on the image forming apparatus 1 so that, among the plural lenses 64 (64a to 64c) belonging to one column, the lens 64b positioned closest to the center in the sub-scanning direction is arranged at the position closed to the light receiving surface 111 of the photosensitive drum 11. By doing so, the optical characteristics of the plurality of lenses 64 can be configured easily.

As illustrated in FIGS. 2 and 4, in each lens column, the lenses 64a to 64c are sequentially arranged so as to be offset by an equal distance in the main-scanning direction (right direction in FIG. 4). That is, in each lens column, a line that connects the centers of the lenses 64a to 64c to one another is inclined at a predetermined angle with respect to the main-scanning direction and the sub-scanning direction.

When seen from the cross section of FIG. 3, the three lenses 64 belonging to one lens column, namely the lenses 64a and 64c, are arranged such that the optical axes 601 of the lenses 64a and 64c are symmetrical with respect to the optical axis 601 of the lens 64b. Moreover, the optical axes 601 of the lenses 64a to 64c are arranged in parallel to each other.

Although the constituent materials of the lens arrays 6 and 6′ are not particularly limited as long as they exhibit the optical characteristics described above, the lens arrays 6 and 6′ are preferably formed of a resin material and/or a glass material, for example.

As the resin material, various kinds of resin materials can be used. Examples thereof include liquid crystal polymers such as polyamides, thermoplastic polyimides and polyamideimide aromatic polyesters; polyolefins such as polyphenylene oxide, polyphenylene sulfide and polyethylene; polyesters such as modified polyolefins, polycarbonate, acrylic (methacrylic) resins, polymethyl methacrylate, polyethylene terephthalate and polybutylene terephthalate; thermoplastic resins such as polyethers, polyether ether ketones, polyetherimide and polyacetal; thermosetting resins such as epoxy resins, phenolic resins, urea resins, melamine resins, unsaturated polyester resins and polyimide resins; photocurable resins; and the like. These can be used individually or in combination of two or more species.

Among these resin materials, resin materials such as thermosetting resins and photocurable resins are preferred because such materials have a relative low thermal expansion coefficient and are rarely thermally expanded (deformed), modified or deteriorated, in addition to the advantages of a relative high refractive index.

In addition, as the glass material, various kinds of glass materials, such as soda glass, crystalline glass, quartz glass, lead glass, potassium glass, borosilicate glass, alkali-free glass, and the like may be used. When a supporting plate 72 of the light-emitting element array 7 is formed of a glass material, the lens arrays 6 and 6′ are preferably formed of a glass material having approximately the same linear expansion rate as the above glass material. By doing so, the positional misalignment of the respective lenses relative to the light-emitting elements due to temperature, variation can be prevented.

When the lens array 6 is formed by using a combination of the described resin and glass materials, a glass substrate formed of a glass material may be used as the support portion 65, for example, as will be described later. In this case, a resin layer formed of a resin material may be formed on one surface of the glass substrate, and the lens surface 62 may be formed on the other surface of the glass substrate opposite the resin layer, thus forming the lens 64 (see FIG. 5). In addition, the lens array 6 may be obtained, for example, by forming a plurality of convex portions, which is formed of a resin material and protrudes in a convex surface shape, on one surface of a flat plate-like member (substrate) which is formed of a glass material.

As illustrated in FIGS. 2 and 3, a spacer 84 is provided between the lens arrays 6 and 6′. The lens arrays 6 and 6′ are bonded together via the spacer 84.

The spacer 84 has a function of regulating a gap length that is a distance between the lens arrays 6 and 6′.

The spacer 84 has a frame•shape which corresponds to the outer peripheral portions of the lens arrays 6 and 6′ and is bonded to these peripheral portions. The spacer 84 is not limited to a frame-shaped member as long as it has the above-described function. The spacer 84 may be configured as a pair of members that correspond to one of the opposing sides of the outer peripheral portions of the lens arrays 6 and 6′. Alternatively, the spacer 84 may be configured as a planar member having through-holes formed therein so as to correspond to optical paths, similar to light shielding members 81 and 82 which are described later.

Although the constituent materials of the spacer 84 are not particularly limited as long as they exhibit the above-described function, a resin material, a metallic material, a glass material, a ceramics material, and the like can be used, for example.

As illustrated in FIG. 3, at a side of the lens array 6 on which the light L is incident, the light-emitting element array 7 is provided with the light shielding member 82, diaphragm member 83, and the light shielding member 81 interposed therebetween. The light-emitting element array 7 has a plurality of groups of light-emitting elements (light-emitting element groups) 71 and a supporting plate (head substrate) 72.

The supporting plate 72 is configured to support each of the light-emitting element groups 71 and is formed of a planar member having a long appearance. The supporting plate 72 is arranged in parallel to the lens array 6.

In addition, the length of the supporting plate 72 in the main-scanning direction is larger than that of the lens array 6 in the main-scanning direction. The length of the supporting plate 72 in the sub-scanning direction is also set to be larger than that of the lens array 6 in the sub-scanning direction.

Although the constituent materials of the supporting plate 72 are not particularly limited, when the light-emitting element groups 71 are provided on the bottom surface side of the supporting plate 72 (that is, bottom emission-type light-emitting elements are used as the light-emitting elements 74), the supporting plate 72 is preferably formed of transparent materials such as various kinds of glass materials or various kinds of plastics. When top emission-type light-emitting elements are used as the light-emitting elements 74, the constituent materials of the supporting plate 72 are not limited to the transparent materials, various kinds of metallic materials, such as aluminum or stainless steel, various kinds of glass materials, various kinds of plastics, and the like may be used individually or in combination thereof. When the supporting plate 72 is formed of various kinds of metallic or glass materials, heat generated by emission of the light-emitting elements 74 is efficiently dissipated through the supporting plate 72. When the supporting plate 72 is formed of various kinds of plastics, the weight of the supporting plate 72 is reduced.

A box-shaped accommodation portion 73 that is open to the supporting plate 72 is provided on the bottom surface side of the supporting plate 72. The plurality of light-emitting element groups 71, wiring lines electrically connected to the light-emitting element groups 71 (the respective light-emitting elements 74), or circuits used for driving the respective light-emitting elements 74 are accommodated in the accommodation portion 73.

The plurality of light-emitting element groups 71 are separated from each other and arranged in a matrix of three rows by n columns (n is an integer of two or more) so as to correspond to the plurality of lenses 64 described above (for example, see FIG. 4). Each of the light-emitting element groups 71 is configured to include a plurality (8 in the present embodiment) of light-emitting elements 74.

The eight light-emitting elements 74 that constitute each of the light-emitting element groups 71 are arranged along a lower surface 721 of the supporting plate 72 of FIG. 3. The light L emitted from each of the eight light-emitting elements 74 is focused (imaged) on the light receiving surface 111 of the photosensitive drum 11 through the corresponding lens 64.

In addition, as illustrated in FIG. 4, the eight light-emitting elements 74 are separated from each other and are arranged in four columns in the main-scanning direction and in two rows in the sub-scanning direction. Thus, the eight light-emitting elements 74 are arranged in a matrix of two rows by four columns. The two adjacent light-emitting elements 74 belonging to one column (column of light-emitting elements) are arranged so as to be offset from each other in the main-scanning direction.

In the eight light-emitting elements 74 that form a matrix of two rows by four columns, two light-emitting elements 74 that are adjacent to each other in the main-scanning direction are supplemented by one light-emitting element 74 in a next row.

There is a limitation in arranging the eight light-emitting elements 74 as closely as possible in one row. However, the arrangement density of the light-emitting elements 74 can be further increased by arranging the eight light-emitting elements 74 so as to be offset from each other as described above. In this way, the recording density of the recording medium P when an image is recorded on the recording medium P is increased further. As a result, a recording medium P carrying thereon an image that has high resolution and multiple gray-scale levels and is clear is obtained.

In addition, although the eight light-emitting elements 74 belonging to one light-emitting element group 71 are arranged in a matrix of two rows by four columns in the present embodiment, the arrangement shape is not limited thereto. For example, the eight light-emitting elements 74 may be arranged in a matrix of four rows by two columns.

As described above, the plurality of light-emitting element groups 71 are arranged in a matrix of three rows by n columns so as to be separated from each other. As illustrated in FIG. 4, the three light-emitting element groups 71 belonging to one column (column of light-emitting element groups) are arranged so as to be offset from each other by an equal distance in the main-scanning direction (right direction in FIG. 4).

Thus, in the light-emitting element groups 71 that form a matrix of three rows by n columns, the gaps between adjacent light-emitting element groups 71 are sequentially supplemented by the light-emitting element group 71 of a next row and the light-emitting element group 71 of a subsequent row.

There is a limitation in arranging the plurality of light-emitting element groups 71 as closely as possible in one row. However, the arrangement density of the light-emitting element groups 71 can be further increased by arranging the plurality of light-emitting element groups 71 so as to be offset from each other as described above. In this way, by the synergetic effect with the fact that the eight light-emitting elements 74 within one light-emitting element group 71 are arranged so as to be offset from each other, the recording density of the recording medium P when an image is recorded on the recording medium P is increased further. As a result, a recording medium P carrying thereon an image that has higher resolution, multiple gray-scale levels, high color reproducibility and is clearer is obtained.

The light-emitting elements 74 are bottom emission-type organic electroluminescence (EL) element. However, the light-emitting elements 74 are not limited to bottom emission-type elements and may be top emission-type elements. In this case, the supporting plate 72 is not required to have optically transparent properties as described above.

When the light-emitting elements 74 are organic EL elements, the gaps (pitches) between the light-emitting elements 74 can be set to be relatively small. In this way, the recording density of the recording medium P when an image is recorded on the recording medium P can be made relatively high. In addition, the light-emitting elements 74 can be formed with highly accurate sizes and at highly accurate positions by using various film-forming methods. As a result, a recording medium P carrying thereon a clearer image is obtained.

In the present embodiment, all of the light-emitting elements 74 are configured to emit red light. Here, (4-dicyanomethylene)-2-methyl-6-paradimethylaminostyryl)-4H-pyrane (DCM), Nile Red and the like are examples of constituent materials of a light-emitting layer that emits red light. However, the light-emitting elements 74 are not limited to those configured to emit red light, but may be configured to emit monochromatic light of another color or white light. Thus, in the organic EL element, the light L emitted from the light-emitting layer can be appropriately set to monochromatic light of an arbitrary color in accordance with the constituent materials of the light-emitting layer.

Since the spectral sensitivity characteristic of the photosensitive drum used in the electrophotographic process is generally set to have a peak in a wavelength range of a red wavelength, which is the emission wavelength of a semiconductor laser, to a near-red wavelength, it is preferable to use the materials capable of emitting red light as described above.

As illustrated in FIG. 3, the light shielding member 82, the diaphragm member 83, and the light shielding member 81 are provided between the lens array 6 and the light-emitting element array 7.

The light shielding members 81 and 82 are configured to prevent crosstalk of the light L between the adjacent light-emitting element groups 71.

A plurality of through-holes (openings) 811 is formed in the light shielding member 81 so as to pass through the light shielding member 81 in the up and down direction (thickness direction) of FIG. 3. These through-holes 811 are arranged at positions corresponding to the respective lenses 64.

Similarly, a plurality of through-holes 821 is formed in the light shielding member 82 so as to pass through the light shielding member 82 in the up and down direction (thickness direction) of FIG. 3. Through-holes 821 are arranged at positions corresponding to the respective lenses 64.

Each of the through-holes 811 and 821 is configured to form an optical path that extends from the light-emitting element group 71 to the corresponding lens 64. In addition, each of the through-holes 811 and 821 has a circular shape in plan view thereof and includes therein the eight light-emitting elements 74 of the light-emitting element group 71 corresponding to each of the through-holes 811 and 821.

Although the through-holes 811 and 821 have a cylindrical shape in the configuration illustrated in FIG. 3, the invention is not limited thereto. For example, the through-holes 811 and 821 may have a circular truncated cone shape that expands upward.

The diaphragm member 83 is provided between the light shielding members 81 and 82.

The diaphragm member 83 is an aperture diaphragm that restricts the amount of light L incident on the lens 64 from the light-emitting element group 71 to a predetermined amount.

In particular, the diaphragm member 83 is disposed in the vicinity of a front-side focal plane of the optical system 60. Therefore, the optical system 60 becomes telecentric on the image side. Even when there is an error in the distance between the light receiving surface 111 and the line head 13 due to mounting errors or the like, it is possible to prevent positional deviation of images that are projected on the light receiving surface 111 after being emitted from the light-emitting elements 74a, 74d, 74b, and 74c (first and second light-emitting elements).

The diaphragm member 83 has a planar or layered shape, and a plurality of through-hole (openings) 831 is formed in the diaphragm member 83 so as to pass through the diaphragm member 83 in the up and down direction (thickness dimension) of FIG. 3. Through-holes 831 are arranged at positions corresponding to the lenses 64 (namely, the above-described through-holes 811 and 821).

In addition, each of the through-holes 831 of the diaphragm member 83 has a circular shape in plan view thereof and has a diameter smaller than that of the through-holes 811 of the light shielding member 81 described above.

The diaphragm member 83 is preferably configured to set a distance to the lens 64 so as to be relatively small. By doing so, light emitted from light-emitting elements 74 that are located at different distances from the optical axis 601 (that is, even when the light-emitting elements 74 are located at different angles of view) can be made incident to approximately the same region of the lens 64.

The light shielding members 81 and 82 and the diaphragm member 83 also have a function of regulating the distance, positional relationship, and attitude between the lens array 6 and the supporting plate 72 with high accuracy.

The distance between the lens surface 62 of each lens 64 and the corresponding light-emitting element group 71 is an important condition (element) that determines the position in the up and down direction of FIG. 3 of the imaging point of the optical system 60 which is described later. Therefore, as described above, when the light shielding members 81 and 82 and the diaphragm member 83 functions as the spacer that regulates the gap length, which is the distance between the lens array 6 and the light-emitting element array 7, an image forming apparatus 1 is obtained that is highly precise and reliable.

Moreover, the light shielding members 81 and 82 and the diaphragm member 83 preferably have at least an inner peripheral surface thereof that has a dark color such as black, brown, or dark blue.

Although the constituent materials of the light shielding members 81 and 82 and the diaphragm member 83 are not particularly limited as long as they are not optically transparent, various kinds of coloring agents, metallic materials such as chrome or chromic oxides, resins having mixed therein carbon black or coloring agents, and the like are examples thereof.

As illustrated in FIGS. 2 and 3, the lens array 6, the light-emitting element array 7, the spacer 84, the light shielding members 81 and 82, and the diaphragm member 83 are collectively accommodated in the casing 9. The casing 9 has a frame member (casing body) 91, a lid member (bottom lid) 92, and a plurality of clamp members 93 that fixedly secures the frame member 91 to the lid member 92 (see FIG. 3).

The frame member 91 has a generally long shape, as illustrated in FIG. 2.

In addition, the frame member 91 has a frame shape, and an inner cavity portion 911 that is open to the upper and lower sides of the frame member 91 is formed in the frame member 91 as illustrated in FIG. 3. The width of the inner cavity portion 911 gradually decreases from the lower side of FIG. 3 from the lower side.

The lens array 6′, the spacer 84, the lens array 6, the light shielding member 82, the diaphragm member 83, the light shielding member 81, and the light-emitting element array 7 are inserted in the inner cavity portion 911, and they are fixed by adhesive, for example. In this way, the lens array 6′, the spacer 84, the lens array 6, the light shielding member 82, the diaphragm member 83, the light shielding member 81, and the light-emitting element array 7 are collectively held on the frame member 91, such that the positions in the main and sub-scanning directions of the lens array 6′, the spacer 84, the lens array 6, the light shielding member 82, the diaphragm member 83, the light shielding member 81, and the light-emitting element array 7 are determined.

An upper surface 722 of the supporting plate 72 of the light-emitting element array 7 is in contact (abutting contact) with a stepped portion 915, which is formed on a wall surface of the inner cavity portion 911, and the lower surface of the second light shielding member 81. The lid member 92 is upwardly inserted into the inner cavity portion 911.

The lid member 92 is formed of a lengthy member having a recess portion 922 in which the accommodation portion 73 is inserted at an upper side thereof. The edge portions of the supporting plate 72 of the light-emitting element array 7 are pinched between the upper end surface of the lid member 92 and the boundary portion 915 of the frame member 91.

Moreover, the lid member 92 is pressed upward by each of the clamp members 93. In this way, the lid member 92 is fixed to the frame member 91. In addition, by the pressed lid member 92, the positional relationships among the light-emitting element array 7, the light shielding members 81 and 82, the diaphragm member 83, and the lens array 6 in the main-scanning direction, the sub-scanning direction, and the up and down direction of FIG. 3 are fixed.

The clamp members 93 are preferably arranged in plural numbers at equal intervals in the main-scanning direction. Accordingly, the frame member 91 and the lid member 92 are pinched uniformly in the main-scanning direction.

The clamp member 93 has a generally U shape in the cross section illustrated in FIG. 3 and is formed by folding a metallic plate. Both ends of the clamp member 93 are bent inward to form claws portions 931. The claw portions 931 are engaged with shoulder portions 916 of the frame member 91.

A curved portion 932 that is curved upward in an arch shape is formed in the middle portion of the clamp member 93. The apex of the curved portion 932 is in pressure-contact with the lower surface of the lid member 92 in a state where the claw portions 931 are engaged with the shoulder portion 916. In this way, the curved portion 932 urges the lid member 92 upwardly in a state where the curved portion 932 is elastically deformed.

When the clamp members 93 that pinch the frame member 91 and the lid member 92 are detached, the lid member 92 can be detached from the frame member 91. Then, maintenance for the light-emitting element array 7, such as replacement and repair, can be performed.

The constituent materials of the frame member 91 and the lid member 92 are not particularly limited, and the same constituent materials as the supporting plate 72 may be used, for example. The constituent materials of the clamp member 93 are not particularly limited, and aluminum or stainless steel may be used, for example. In addition, the clamp member 93 may also be formed of a hard resin material.

Moreover, although not illustrated in the drawings, the frame member 91 has spacers that are provided at both ends in the longitudinal direction thereof so as to protrude upward. The spacers are configured to regulate the distance between the light receiving surface 111 and the lens array 6.

### Optical System

Next, the optical system 60 of the line head 13 is described in detail with reference to FIGS. 5-7.

As described above, in the line head 13, a pair of lenses 64 and 64′ corresponding to the light-emitting element group 71 are arranged in the optical axis direction (third direction). As illustrated in FIG. 5, this pair of lenses 64 and 64′ constitutes the optical system 60 that images the light L from the light-emitting elements 74 belonging to the corresponding light-emitting element group 71.

In the following description, a cross section (first cross section) that contains the optical axis 601 and is in parallel to the main-scanning direction is referred to as a “main-cross section”, and a cross section (second cross section) that contains the optical axis 601 and is perpendicular to the main-cross section is referred to as a “sub-cross section”. FIG. 5 illustrates a view of the optical system 60 taken along the main-cross section. In the following description, if necessary, the optical system 60 formed by a pair of lenses 64a and 64a′ is referred to as an “optical system 60a”, the optical system 60 formed by a pair of lenses 64b and 64b′ is referred to as an “optical system 60b”, and the optical system 60 formed by a pair of lenses 64c and 64c′ is referred to as an “optical system 60c”. The light-emitting elements 74a, 74b, 74c, and 74d are disposed at different positions in the main-scanning direction (first direction), and an arbitrary two of these light-emitting elements 74a, 74b, 74c, and 74d constitute first or second light-emitting elements.

The optical system 60 images the light L having passed through the through-holes (aperture diaphragm) 831 of the diaphragm member 83 in the vicinity of the light receiving surface 111 of the photosensitive drum 11 (that is, the light is projected onto the light receiving surface 111). In this embodiment, the optical system 60 is telecentric on the image side.

In this embodiment, the optical system 60 is plane-symmetrical (mirror-symmetrical) with respect to a symmetry plane perpendicular in the main-scanning direction (first direction), and the optical system 60 is plane-symmetrical (mirror-symmetrical) with respect to a symmetry plane perpendicular in the sub-scanning direction (second direction).

In this manner, the optical system 60 has a first symmetry plane that is perpendicular in the first direction and a second symmetry plane that is perpendicular in a second direction orthogonal to the first direction, and an intersection of the first and second symmetry planes is defined.

When the optical system 60 is rotationally symmetrical, the intersection of the first and second symmetry planes is identical to the optical axis. However, when the optical system 60 is not rotationally symmetrical, strictly speaking, there is a case where the optical axis of the optical system 60 is sometimes not defined. In such a case, the intersection of the symmetry planes is treated as the optical axis.

Plane-symmetrical means that the shapes on the lens surfaces, of the light having emitted from the light-emitting elements 74 and passed through the aperture diaphragm 831, are symmetrical on regions through which the light pass the respective lens surfaces.

When light is emitted from an intersection (object point) of the lower surface 721 of the supporting plate 72 and the optical axis 601, the optical system 60 images the light at an imaging point FP.

Moreover, the optical system 60 images the light L emitted from the light-emitting element 74 on an imaging point IFP in the vicinity of the light receiving surface 111. More specifically, as illustrated in FIG. 6, the optical system 60 causes the light L emitted from the light-emitting element 74 to be imaged at the imaging point IFPT on the T-T cross section and at the imaging point IFPS on the S-S cross section.

Here, the T-T cross section is a plane (meridional cross section) including the emission point (object point) of the light-emitting element 74 and the optical axis 601. The S-S cross section is a plane (spherical cross section) that includes the principal ray of the light emitted from the light-emitting element 74 to converge at the imaging point IFP and that is orthogonal to the T-T cross section (meridional cross section).

As described above, the optical system 60 includes the lens surface (first lens surface) 62 and the lens surface (second lens surface) 62′ that is provided on a side of the lens surface 62 opposite to the light-emitting element 74.

In particular, in the optical system 60, when the curvature on the optical axis of the lens surface 62 on the main-cross section is defined as C_{1X}, the curvature on the optical axis of the lens surface 62′ on the main-cross section is defined as C_{2X}, the curvature on the optical axis of the lens surface 62 on the sub-cross section is defined as C_{1Y}, and the curvature on the optical axis of the lens surface 62′ on the sub-cross section is defined as C_{2Y}, the absolute values |C_{1X}|, |C_{2X}|, |C_{1Y}|, and |C_{2Y}| of the curvatures satisfy the following relationship:

|C_{1X}|<|C_{1Y}|; and

|C_{2X}|>|C_{2Y}|

In this embodiment, it is assumed that the optical axis 601 is identical to a line that connects the center of the lens surface 62 and the center of the lens surface 62′ (namely, a straight line passing through the center of the lens surface 62 and the center of the lens surface 62′).

Therefore, the image-surface curvature of the optical system 60 is suppressed to be small. For this reason, variation in the spot size (spot diameter) on the projection surface (light receiving surface 111) due to a different angle of view is decreased, thus suppressing unevenness in the spot size. As a result, the line head 13 realizes a high-accuracy exposure process.

More specifically, the optical system 60 configured with the lenses 64 and 64′ having the lens surfaces having the above-mentioned curvatures is configured such that the light L1 emitted from the light-emitting element 74a is imaged at imaging points IFPT1 and IFPS1, the light L2 emitted from the light-emitting element 74b is imaged at imaging points IFPT2 and IFPS2, the light L3 emitted from the light-emitting element 74c is imaged at imaging points IFPT3 and IFPS3, and the light L4 emitted from the light-emitting element 74d is imaged at imaging points IFPT4 and IFPS4, as illustrated in FIG. 7.

The imaging points IFPT1, IFPT2, IFPT3, and IFPT4 are imaging points on the above-described T-T cross section (meridional cross section) at respective angles of view. Moreover, the imaging points IFPS1, IFPS2, IFPS3, and IFPS4 are imaging points on the above-described S-S cross section (spherical cross section) at respective angles of view. In this description, the imaging point refers to a position at which the spot size of light (namely, the width on the T-T or S-S cross section) becomes the smallest by the imaging function.

As illustrated in FIG. 7, the imaging points IFPT1, IFPT2, IFPT3, and IFPT4 are located on a curved image surface IT that is recessed toward the light-emitting elements 74 (namely, the light source side). Here, the imaging points IFPT1 and IFPT4 are located symmetrical with respect to the optical axis 601, and the imaging points IFPT2 and IFPT3 are located symmetrical with respect to the optical axis 601.

As illustrated in FIG. 7, the imaging points IFPS1, IFPS2, IFPS3, and IFPS4 are located on a curved image surface IS that is recessed toward the light-emitting elements 74. Here, the imaging points IFPS1 and IFPS4 are located symmetrical with respect to the optical axis 601, and the imaging points IFPS2 and IFPS3 are located symmetrical with respect to the optical axis 601.

The curved shapes of the image surfaces IS and IT are not limited to the described shapes. In FIG. 7, the curved shapes of the image surfaces IS and IT are exaggerated for convenience of explanation.

Since the optical system 60 satisfies the above-described relationship of |C_{1X}|, |C_{2X}|, |C_{1Y}|, and |C_{2Y}|, it is not only possible to suppress the image-surface curvatures on the T-T cross section and the S-S cross section to be small, but also to suppress the distance between the image surface IS and the image surface IT to be small.

As described above, the light-emitting elements 74a and 74d (second light-emitting elements) are located at positions distant from the optical axis 601 in the main-scanning direction (first direction) compared to the light-emitting elements 74b and 74c (first light-emitting elements) and therefore have a larger angle of view than the light-emitting elements 74b and 74c.

Since the light-emitting elements 74a and 74d and the light-emitting elements 74b and 74c have different angles of view, it is possible to decrease the distance G_{T} in the optical axis direction between the imaging point IFPT1 and the imaging point IFPT2 (and the distance in the optical axis direction between the imaging point IFPT3 and the imaging point IFPT4). Moreover, it is possible to decrease the distance G_{S} in the optical axis direction between the imaging point IFPS1 and the imaging point IFPS2 (and the distance in the optical axis direction between the imaging point IFPS3 and the imaging point IFPS4).

Furthermore, it is possible to decrease the distance between the imaging point IFPT1 and the imaging point IFPS1, the distance between the imaging point IFPT2 and the imaging point IFPS2, the distance between the imaging point IFPT3 and the imaging point IFPS3, and the distance between the imaging point IFPT4 and the imaging point IFPS4, respectively.

For this reason, it is possible to suppress a variation in the amount of offsets on the optical axis direction of the respective imaging points IFPT1 to IFPT4 (IFPT) and the respective imaging points IFPS1 to IFPS4 (IFPS) from the light receiving surface 111 low.

As a result, variation in the spot size and the spot shape of the light L1 to L4 on the light receiving surface 111 is suppressed, thus realizing a high-accuracy exposure process.

Here, the optical system 60 is configured such that the cross-sectional area on the light receiving surface 111, of the spot of each of the light L1 and L4 emitted from the light-emitting elements 74a and 74d (first light-emitting elements) is the same as the cross-sectional area on the light receiving surface 111, of the spot of each of the light L2 and L3 emitted from the light-emitting elements 74b and 74c (second light-emitting elements). By doing so, an apparent concentration difference on the projection surface (light receiving surface 111) between the pixel formed by the light-emitting elements 74a and 74d and the pixel formed by the light-emitting elements 74b and 74c is decreased.

The optical system 60 having such characteristics can be realized by appropriately setting the shape of the lens surface 62 of the lens 64 and the shape of the lens surface 62′ of the lens 64′ as described below.

As illustrated in FIG. 5, the lens 64 is formed on the support portion 65 that is formed of a glass material, for example. The lens 64 has a lens surface 62 on an opposite side to the support portion 65.

Similar to the lens 64, the lens 64′ is formed on a support portion 65′ that is formed of a glass material, for example. The lens 64′ has a lens surface 62′ on an opposite side to the support portion 65′.

As the definition formula for defining the surface shape of the lens surface 62 of the lens 64 and the surface shape of the lens surface 62′ of the lens 64′, a definition formula (icy polynomial surface) expressed by Formula 1 below can be used, for example (see Examples below for more details). In this way, the optical system 60 having the above-described characteristics can be realized relatively easily and reliably.

$$Z = \frac{{cr}^{2}}{1 + \sqrt{1 - ( 1 + K ) {c}^{2} {r}^{2}}} + {Ax}^{2} + {By}^{2} + {Cx}^{4} + {Dx}^{2} {y}^{2} + {Ey}^{4} + {Fx}^{6} + {Gx}^{4} {y}^{2} + {Hx}^{2} {y}^{4} + {Iy}^{6} \qquad Formula 1$$

In the definition formula expressed by Formula 1 above,

r²=x²+y², and

x: coordinate in main-scanning direction (first direction)
y: coordinate in sub-scanning direction (second direction)
z: coordinate in optical axis direction (third direction)
c: curvature on optical axis
K: conic coefficient
A to I: aspheric coefficient

The respective coefficients c, K, A to I of the definition formula are appropriately set such that the curvatures of the lens surface 62 of the lens 64 and the lens surface 62′ of the lens 64′ satisfy the above-described relationship.

That is, the coefficients c, K, and A to I of the above definition formula are set such that, when the curvature on the optical axis of the lens surface 62 on the main-cross section is defined as C_{1X}, the curvature on the optical axis of the lens surface 62′ on the main-cross section is defined as C_{2X}, the curvature on the optical axis of the lens surface 62 on the sub-cross section is defined as C_{1Y}, and the curvature on the optical axis of the lens surface 62′ on the sub-cross section is defined as C_{2Y}, the absolute values |C_{1X}|, |C_{2X}|, |C_{1Y}|, and |C_{2Y}| of the curvatures satisfy the following relationship:

|C_{1X}|<|C_{1Y}|; and

|C_{2X}|>|C_{2Y}|.

When at least one of the coefficients c, K and A to I of the definition formula is changed, the lens surface 62 of the lens 64 and the lens surface 62′ of the lens 64′ will be expressed by different definition formulas.

According to the line head 13 having the optical system 60 described above, image-surface curvature of the optical system 60 is suppressed to be small. Therefore, variation in the spot size (spot diameter) on the projection surface (light receiving surface 111) due to a different angle of view is decreased, thus suppressing unevenness in the spot size. As a result, the line head 13 realizes a high-accuracy exposure process.

Moreover, according to the image forming apparatus 1 having the line head 13, by realizing the above-described high-accuracy exposure process, a high-quality image in which concentration unevenness is suppressed is obtained.

While a line head and image forming apparatus according to embodiments of the invention has been described, the invention is not limited thereto. Each of the components of the line head and the image forming apparatus can be replaced with a component having an arbitrary configuration that realizes the same function. In addition, other arbitrary structures may be added.

Furthermore, in the lens arrays, a plurality of lenses is not limited to being arranged in a matrix of two rows by n columns. For example, a plurality of lenses in each of the lens arrays may be arranged in a matrix of three rows by n columns, four rows by n columns, and the like.

Moreover, one optical system may be configured by a plurality of lenses, and may be configured to have one or three or more lens surfaces.

Furthermore, in the above-described embodiment, although the light-emitting elements are described as being arranged in a matrix of one row by n columns for the convenience of explanation, the arrangement is not limited to this, and the light-emitting elements may be arranged in a matrix of two rows by n columns, three rows by n columns, and the like.

Furthermore, in the above-described embodiment, although organic ELs were used as an example of the light-emitting elements 74, the light-emitting elements 74 may be LEDs (light-emitting diodes).

### EXAMPLES

Specific examples of the invention are now described.

### Example

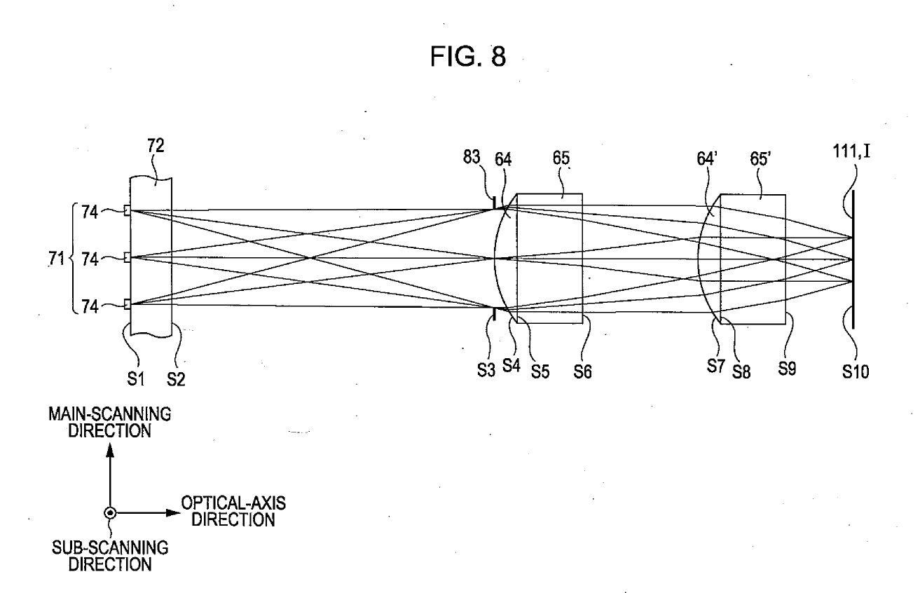

A line head having the optical system as illustrated in FIG. 8 was produced. FIG. 8 is a cross-sectional view taken along the main-cross section, illustrating the optical system included in the line head according to an Example of the invention.

The line head of the present example had the same configuration as the line head illustrated in FIGS. 3 and 5, except that three light-emitting elements 74 were arranged in the main-scanning direction.

Here, in the main-cross section, the three light-emitting elements 74 arranged in the main-scanning direction were arranged symmetrically to the optical axis.

Moreover, a glass material was used as the constituent materials of the support portions 65 and 65′, and a resin material was used as the constituent materials of the lenses 64 and 64′.

The surface configuration of the optical system of the line head is shown in Table 1.

TABLE 1

| | Curvature at | | Refractive index |
|---|---|---|---|
| Surface | the center of | Surface | at reference |
| number | main-cross section | spacing | wavelength |
| S1: Light | r1 = ∞ | d1 = 0.55 | n1 = 1.499857 |
| source plane | | | |
| S2: Emission | r2 = ∞ | d2 = 4.04066 | |
| surface of | | | |
| glass substrate | | | |
| S3: Aperture | r3 = ∞ | d3 = 0.01 | |
| diaphragm | | | |
| S4: Incidence | r4 = (separately | d4 = 0.3 | n4 = 1.525643 |
| surface of resin | described for | | |
| portion | each surface shape) | | |
| S5: Resin- | r5 = ∞ | d5 = 0.9 | n5 = 1.536988 |
| glass boundary | | | |
| surface | | | |
| S6: Emission | r6 = ∞ | d6 = 1.34798 | |
| surface of | | | |
| glass substrate | | | |
| S7: Incidence | r7 = (separately | d7 = 0.3 | n7 = 1.525643 |
| surface of resin | described for | | |
| portion | each surface shape) | | |
| S8: Resin- | r8 = ∞ | d8 = 0.9 | n8 = 1.536988 |
| glass boundary | | | |
| surface | | | |
| S9: Emission | r9 = ∞ | d9 = 0.86 | |
| surface of | | | |
| glass substrate | | | |
| S10: Image | r10 = ∞ | | |
| surface | | | |

As illustrated in FIG. 8, in Table 1, a surface S1 is a boundary surface (light source plane) of the light-emitting element 74 and the supporting plate 72, a surface S2 is a surface (emission surface of a glass substrate) of the supporting plate 72 opposite to the light-emitting element 74, a surface S3 is a surface (aperture diaphragm) of the diaphragm member 83 close to the light-emitting element 74, a surface S4 is the lens surface 62 (incidence surface of a resin portion) of the lens 64, a surface S5 is a boundary surface (resin-glass boundary surface) of the lens 64 and the support portion 65, a surface S6 is a surface (emission surface of the glass substrate) of the support portion 65 opposite to the lens 64, a surface S7 is the lens surface 62′ (incidence surface of the resin portion) of the lens 64′, a surface S8 is a boundary surface (resin-glass boundary surface) of the lens 64′ and the support portion 65′, a surface S9 is a surface (emission surface of the glass substrate) of the support portion 65′ opposite to the lens 64′, and a surface S10 is the light receiving surface 111 (projection surface).

Moreover, a surface spacing d1 is a spacing between the surface S1 and the surface 82, a surface spacing d2 is a spacing between the surface S2 and the surface S3, a surface spacing d3 is a spacing between the surface S3 and the surface S4, a surface spacing d4 is a spacing between the surface S4 and the surface S5, a surface spacing d5 is a spacing between the surface S5 and the surface S6, a surface spacing d6 is a spacing between the surface S6 and the surface S7, a surface spacing d7 is a spacing between the surface S7 and the surface S8, a surface spacing d8 is a spacing between the surface S8 and the surface S9, and a surface spacing d9 is a spacing between the surface S9 and the surface S10.

Furthermore, a refractive index at reference wavelength is the refractive index on each of the respective surfaces with light having the reference wavelength.

The wavelength (reference wavelength) of the light emitted from the light-emitting element 74 was 690 nm, the object-side numerical aperture was 0.153, the total width of the object-side pixel group in the main-scanning direction was 1.155 mm, the total width of the object-side pixel group in the sub-scanning direction was 0.127 mm, and the optical magnification of the optical system 60 was −0.5039.

Furthermore, the surface shapes of the lens surface 62 (surface S4) and the lens surface 62′ (surface S7) were defined using the coefficients shown below in the definition formula given by Formula 1.

### Coefficients of Definition Formula of the Lens Surface 62

c=1/1.486847

### K=−0.9899585

### A=0.0

### B=0.0233308

### C=0.000462012

### D=0.00306875

### E=−0.002558038

### F=−0.001691206

### G=−0.003828969

### H=0.00349959

### I=0.00407146

Here, the curvature C_{1X} on the optical axis in the main-cross section of the lens surface 62 was 1/1.486847, and the curvature C_{1Y} on the optical axis in the sub-cross section of the lens surface 62 was 1/1.390383.

### Coefficients of Definition Formula of the Lens Surface 62′

c=1/1.212147

### K=0.0

### A=0.0

### B=−0.0478282

### C=−0.06611107

### D=−0.1905610

### E=−0.0946444

### F=−0.0734422

### G=−0.2383737

### H=−0.275994

### I=−0.1187387

Here, the curvature C_{2X} on the optical axis in the main-cross section of the lens surface 62′ was 1/1.212147, and the curvature C_{2Y} on the optical axis in the sub-cross section of the lens surface 62′ was 1/1.371128.

### EVALUATION

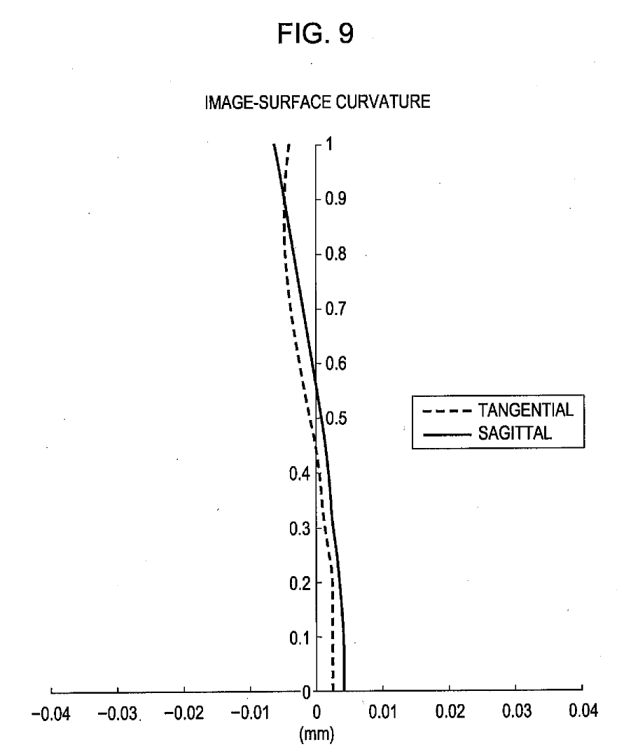

The optical system of the example obtained in the above-described manner had an image-surface curvature on the main-cross section as shown in FIG. 9. In FIG. 9, the horizontal axis represents the image-surface curvature, which represents the offsets of the imaging points, and is defined such that, when the 0 (reference) point of the horizontal axis corresponds to an image-surface curvature in the vicinity of the optical axis, the left side is the light source side and the right side is the image side. Moreover, the image surface (imaging point) on the spherical cross section (sagittal) is illustrated by a solid line, and the image surface (imaging point) on the meridional cross section (tangential) is illustrated by a broken line.

As is evident from FIG. 9, in this example, on any of the meridional (T-T) and spherical (S-S) cross sections, the image-surface curvature was suppressed to be small.

Moreover, in an image forming apparatus obtained by mounting the line head of the example on the image forming apparatus of FIG. 1, high-quality images in which concentration unevenness was suppressed were obtained.

What is claimed is:

1. A line head comprising:
light-emitting elements arranged in a first direction; and
an optical system that images light emitted from the light-emitting elements on a image surface, wherein:
the optical system is provided with:
a first lens surface having refractive power; and
a second lens surface having refractive power that is provided on a side of the first lens surface opposite to the light-emitting elements; and
in a cross section in the first direction including an optical axis of the optical system and a cross section in a second direction including the optical axis, the second direction being orthogonal to the cross section in the first direction, the curvatures of the first and second lens surfaces satisfy the following relationships:

|C_{1X}|<|C_{1Y}|
|C_{2X}|>|C_{2Y}|

where, |C_{1X}| is the absolute value of the curvature on the optical axis of the first lens surface on the cross section in the first direction;

|C_{2X}| is the absolute value of the curvature on the optical axis of the second lens surface on the cross section in the first direction;

|C_{1Y}| is the absolute value of the curvature on the optical axis of the first lens surface on the cross section in the second direction; and

|C_{2Y}| is the absolute value of the curvature on the optical axis of the second lens surface on the cross section in the second direction.

2. The line head according to claim 1, wherein the optical system includes a first lens having the first lens surface and a second lens having the second lens surface.

3. The line head according to claim 2, wherein the first lens has a flat surface on an opposite side to the first lens surface.

4. The line head according to claim 3, wherein the first lens surface of the first lens opposes the light-emitting elements.

5. The line head according to claim 1, wherein an aperture diaphragm is provided close to a front-side focal plane of the optical system.

6. An image forming apparatus comprising:
a latent image carrier on which a latent image is formed; and
a line head that performs exposure on the latent image carrier so as to form the latent image, wherein
the line head comprises:
light-emitting elements arranged in a first direction; and
an optical system that images light emitted from the light-emitting elements on a latent image carrier, wherein:
the optical system is provided with:
a first lens surface having refractive power; and
a second lens surface having refractive power that is provided on a side of the first lens surface opposite to the light-emitting elements; and
in a cross section in the first direction including an optical axis of the optical system and a cross section in a second direction including the optical axis, the second direction being orthogonal to the cross section in the first direction, the curvatures of the first and second lens surfaces satisfy the following relationships:

|C_{1X}|<|C_{1Y}|; and

|C_{2X}|>|C_{2Y}|,
where, |_{1X}| is the absolute value of the curvature on the optical axis of the first lens surface on the cross section in the first direction;

|C_{2X}| is the absolute value of the curvature on the optical axis of the second lens surface on the cross section in the first direction;

|C_{1Y}| is the absolute value of the curvature on the optical axis of the first lens surface on the cross section in the second direction; and

|C_{2Y}| is the absolute value of the curvature on the optical axis of the second lens surface on the cross section in the second direction.
